(19) United States
(12) Patent Application Publication
(10) Pub. No.: US 2025/0182184 A1
(43) Pub. Date: Jun. 5, 2025

(54) SHARE-TO-PAY E-COMMERCE SOLUTION

(71) Applicant: Abercrombie & Fitch Trading Co., New Albany, OH (US)

(72) Inventor: Bret G. DAHLGREN, New Albany, OH (US)

(21) Appl. No.: 19/052,983

(22) Filed: Feb. 13, 2025

Related U.S. Application Data
(63) Continuation of application No. PCT/US2023/030212, filed on Aug. 15, 2023.
(60) Provisional application No. 63/398,155, filed on Aug. 15, 2022.

(51) Int. Cl. G06Q 30/0601; G06F 16/955; G06Q 10/083; G06Q 20/40

(52) U.S. Cl. CPC G06Q 30/0633; G06F 16/955; G06Q 10/083; G06Q 20/4014; G06Q 30/0621; G06Q 30/0641; G06Q 2220/00

(57) ABSTRACT

The present disclosure involves systems, software, and computer-implemented methods for users to identify a set of items from a merchant in a virtual shopping cart and share a request for purchase, by another, of those items. One example method includes associating items with a first user's first electronic shopping cart. A request is received from the first user to initiate a share to pay operation for the at least one item. A token is generated corresponding to the shared item, and the generated token is provided to the first user. A request associated with the generated token is received from a second user different than the first, and, based on the request and generated token, the items of the first user's first electronic shopping cart are added to a second electronic shopping cart of the second user based on the generated token.

### CROSS-REFERENCE TO RELATED APPLICATIONS

This application claims the benefit of priority to U.S. Application No. 63/398,155, filed on Aug. 15, 2022, the contents of which are hereby incorporated by reference.

### TECHNICAL FIELD

The present disclosure relates to computer-implemented methods, software, and systems for e-Commerce payments.

### BACKGROUND

When shoppers visit websites and/or physical stores, many times they may not have the funds to immediately purchase items on their personal wish lists, or items that they see in store. In many cases, particularly where a shopper does not hold purchasing power, a return trip with a parent, friend, or significant other is needed to show the item to that person, and, in some cases, get approval of and payment for their selection. In some cases, online shopping carts may remain idle until they are in the same physical space as the payor.

### SUMMARY

The present disclosure involves systems, software, and computer-implemented methods for users to identify a set of items from a merchant in a virtual shopping cart and share a request for purchase, by another, of those items. One example method includes associating at least one item with a first electronic shopping cart associated with a first user, where the first electronic shopping cart associated with a merchant. A request to initiate a share to pay operation for the at least one item associated with the first electronic shopping cart is received from the first user. In response to that request, a token corresponding to the at least one item associated with the first electronic shopping cart is generated. The generated token is then provided to the first user. A request associated with the generated token is then received from a second user different than the first user. Based on the generated token, an identity of the first user and the at least one item associated with the first electronic shopping cart are identified. A second electronic shopping cart associated with the second user is then populated with the at least one item associated with the first electronic shopping cart, wherein the second electronic shopping cart is associated with the merchant.

In some instances, populating the second electronic shopping cart associated with the second user with the at least one item associated with the first electronic shopping cart comprises associating the at least one item from the first electronic shopping cart with the first user. In some of those instances, associating the at least one item from the first electronic shopping cart with the first user comprises visually associating the first user with each of the at least one item in a graphical user interface (GUI) presenting the second electronic shopping cart to the second user.

In some instances, providing the generated token to the first user comprises generating a message payload associated with the requested share to pay operation, wherein the message payload includes the generated token and at least one link to a uniform resource locator (URL) corresponding to a mobile application associated with the merchant, and wherein the message payload is provided to the first user to transmit to the second user, wherein the second user is selected from a plurality of potential recipients. In some of those instances, the generated message payload is associated with at least one thumbnail of at least one of the at least one items, wherein the at least one thumbnail is obtained from a catalog associated with the merchant.

The method can further include, after populating the second electronic shopping cart with the at least one item associated with the first electronic shopping cart, receiving an indication from the second user to modify a particular item from the at least one item associated with the first electronic shopping cart included in the second electronic shopping cart, and updating the second electronic shopping cart based on the received indication to modify the particular item.

In some instances, the method can further include receiving, from the second user, a request to perform a purchase operation for the populated second electronic shopping cart, wherein the purchase operation includes purchasing the at least one item associated with the first electronic shopping cart included in the second electronic shopping cart on behalf of the first user. In some of those instances, the method can further include initiating, after the purchase operation is complete, a shipping process to deliver the at least one item to the first user.

While generally described as computer-implemented methods, some or all of the aspects may be computer-implemented software embodied on tangible and non-transitory media that processes and transforms the respective data or further included in respective systems or other combinations of devices for performing the described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for users to identify a set of items from a merchant in a virtual shopping cart and share a request for purchase, by another, of those items, in accordance with implementations of the present disclosure.

FIG. 2 illustrates an example method for sharing of virtual shopping carts, in accordance with implementations of the present disclosure.

FIG. 3 illustrates an example method for sharing of virtual shopping carts from the perspective of a user requesting a share to pay operation, in accordance with implementations of the present disclosure.

FIGS. 4A-E illustrate example screenshots from the perspective of a user requesting a share to pay operation in one implementation of the present disclosure.

FIG. 5 illustrates an example method for sharing of virtual shopping carts from the perspective of a user receiving a request to perform a share to pay operation, in accordance with implementations of the present disclosure.

FIGS. 6A-C illustrate example screenshots from the perspective of a user requesting a share to pay operation in one implementation of the present disclosure.

FIG. 7 illustrates a swimlane diagram of example interactions between a requesting client device, a receiving client device, and a backend eCommerce system for performing a share to pay interaction, in accordance with implementations of the present disclosure.

### DETAILED DESCRIPTION

The present solution allows users (also, “shoppers,” and “customers”) to interact in a novel manner with eCommerce sites and web-based applications to provide an easy-to-use sharing method. In such solutions, users can identify items for purchase and add them to their virtual shopping cart. Once there, they can select a share to pay process for those items, which can allow one or more potential purchasers to receive the shared user shopping carts with the identified items for purchase via messaging or other communication tools or channels. When the shared message in interacted with, the solution can populate the requested items into the potential purchasers virtual shopping cart and associate those items with the requesting user. If the purchase is completed by the potential purchaser, then the sale can be completed and the items can be shipped or otherwise made available to the requesting user.

In one implementation, shoppers in a mobile application or website can add their selected products to their virtual shopping cart as they browse online or in-store. When ready to check out, the shopper can request a share to pay process, where they can provide their selected item to one or more others to review and potentially pay for the items on their behalf. In some instances, requesting the share to pay process can include interaction with a Share2Pay or other related button or graphical user interface (GUI) icon. Once the icon is selected, a virtual token associated with the shopper and their specific items in their virtual shopping cart can be created. The token can then be included or embedded within a link, which can be shared with one or more other persons, who may be potential purchasers for the shopper. Any suitable method of sharing the link can be used, including messaging functionality built within a mobile application of the retailer, through external messaging applications, or through email, among others. When the purchaser receives the link, they can activate it to launch either the mobile application associated with the retailer or the retailer's website. The backend system can use the token to identify the particular items in the corresponding virtual shopping cart from the shopper should be added to the purchaser's virtual shopping cart. Once identified, those items are added to the purchaser's virtual shopping cart along with an indication that the items are associated with a share to pay request from the shopper. The purchaser can review the items and pay for them, allowing the shopper to get approval and payment from the third-party. In addition, the purchaser can edit the shopping cart before finalizing the transaction, including changing specifics for the item (e.g., color, size, etc.), as well as adding or removing items before checking out.

In another implementation, a mobile app or website associated with a retailer can identify one or more item identified as a potential share within the user's shopping cart. In some instances, this may be all or some of the items already included in the current virtual shopping cart of the user, and may be identified during or prior to a share action via the mobile app or website. In some cases, such items may be in a wish list instead of the shopping cart ready to purchase.

Upon indication to share, the described solution can call an application programming interface (API) to identify the identified items for sharing from the cart, and can generate and return a token to the user's mobile app used to represent those items. The user may, concurrently, before, or after the generation of the token, identify a particular messaging application or communication channel through which to send the request for another person to purchase the item for the user. Example channels can include iMessage, WeChat, Facebook Messenger, SMS/MMS, and others. In combination with the selection, a new message in a corresponding application can be generated. For example, if the user has selected Apple's Messages app as the application in question, an iMessage or other rich message can be generated to be used in sending the request to share to another user. In some instances, the selection may be generated using a correspond operating system's share functionality, such as iOS's Share Sheet. In doing so, a payload for the message or communication can be generated in combination with the generated token. In some instances, an optional message can be input by the user for inclusion in the message.

Upon initiating the share, the payload can include images of the specific items that are being shared, any optional message added to the selection, and a share-specific link. The share-specific link can include or otherwise be linked to the particular generated token, such that activation of the link allows other users (other than the requesting user) to open a corresponding retailer app or website with those shared items ready for immediate purchase on the requesting user's behalf. The share-specific link may also include a desktop uniform resource locator (URL) that can be used to visit the retailer's main website. When sending the share-specific link, the link can be updated, for example, by the messaging or communication app or tool, and can present a combined image and link payload that allows users to both see the items shared (e.g., as thumbnails) and an actionable link that can be activated by the other user's mobile device to move directly to the shared shopping cart.

Once the recipient activates the link via the messaging tool, their respective system can determine whether they have the retailer's specific app or application installed on their device. If so, the token embedded in the link can be used to open the corresponding retailer app on the device, as well as to connect to the shared items of the requesting user. The information can be stored upon initial sharing in any suitable storage or database, such that immediate connections and population of shared shopping carts can be made upon opening of the link. The requesting user's shipping and customer information can be populated to complete the purchase, and those items can be purchased through the normal shopping interactions on then mobile app. In some instances, customer information of the requesting user may be limited, and only an indication of name or identification may be provided to the recipient's system.

In some instances, multiple shares may be received from multiple different requesting users. If one person (e.g., Cameron) shared a shirt, and then another person (e.g., Jimmy) shared the exact same item (e.g., a t-shirt) and both links were activated prior to either of the requested items being purchased, the user who activated those links would show two separate items in their shopping bag. Each of those items can be specially identified as “Shared from Cameron” and “Shared from Jimmy”, respectively. If the same link is activated twice, that is, if Cameron's single link is activated twice, then only one instance of the item is included in the shopping cart of the recipient user. Additionally, in some instances, if an item is added via the share, but then is removed from the shopping cart, re-activating the link may, in some cases, re-add the shared item to the items in the activating user's shopping cart. By separating the shares, the present solution can manage multiple requests and link the same item to different users in the same shopping cart, as well as to the different customer information for shipping and completion of any shared request purchases.

Upon completion of the selections and completing the purchase via the app, a shared purchase indication and confirmation is presented, and information related to the delivery to the requesting user can be provided.

Returning to the above, in instances where the user interacting with the sent link does not have the retailers app installed, link information to the retailers website, or a request to download the retailer app via the appropriate app store, can be used to complete the process. In those instances, the shopping cart may not specifically identify the added items as shared with a particular user.

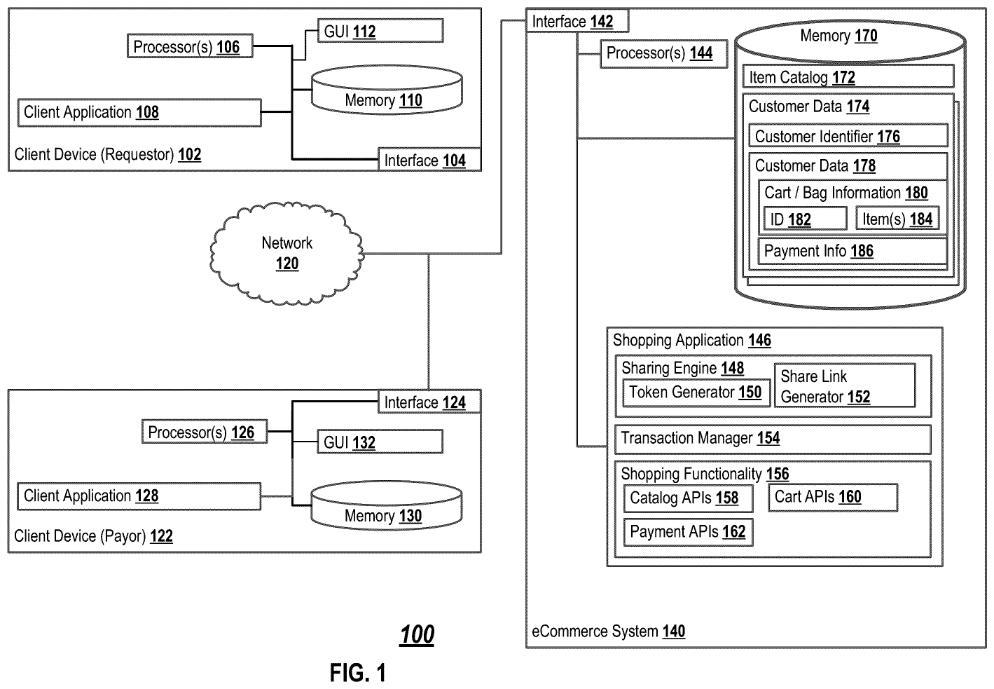

FIG. 1 is a block diagram illustrating an example system 100 for users to identify a set of items from a merchant in a virtual shopping cart and share a request for purchase, by another, of those items, in accordance with implementations of the present disclosure. Specifically, the illustrated system 100 includes or is communicably coupled with an eCommerce system 140, a client device of a requestor 102 (“requester client device 102”), a client device of a payor 122 (“payor client device”), and a network 108. Although shown separately, in some implementations, functionality of two or more systems or servers may be provided by a single system or server. In some implementations, the functionality of one illustrated system, server, or component may be provided by multiple systems, servers, or components, respectively. For example, various systems used to assist in performing payment operations, including credit card payments, are omitted for simplicity. In some instances, the eCommerce system 140 may be specific to a single retailer. However, in some instances, the eCommerce system 140 may be used by a plurality of retailers, or may be a centralized system used by various retailers and eCommerce systems.

As illustrated, the requestor client device 102 can be any mobile computing devices, such as smartphones, laptops, tablets, or other devices, or fixed computing devices such as a desktop computer, kiosk, or other suitable device. As illustrated, client device 102 may include an interface 104, one or more processors 106, a client application 108 (or multiple applications), and memory 110. Although illustrated as a single processor 106 in FIG. 1, multiple processors can be used according to particular needs, desires, or particular implementations of the system 100. Each processor 106 can be a central processing unit (CPU), an application specific integrated circuit (ASIC), a field-programmable gate array (FPGA), or another suitable component. Generally, the processor 106 executes instructions and manipulates data to perform the operations associated with the client device 102. Specifically, the processor 106 executes some of the algorithms and operations described in the illustrated figures, as well as the various software modules and functionality, including the functionality for sending communications to and receiving transmissions from other client devices, such as client device 122, as well as communication with network 120 and/or the eCommerce system 140, as well as to other devices and systems. Each processor 106 can have a single or multiple core, with each core available to host and execute an individual processing thread.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, Swift, any suitable version of 4GL, as well as others.

Client application 108 can be a generic web browser allowing access to one or more web pages and web applications, or may be a stand-alone application with functionality for connecting to eCommerce system 140. In particular, when the client device 102 is a mobile device, such as a smartphone or tablet, the client application 108 may be a mobile application specific to the merchant, which may allow the client application 108 to access the eCommerce system 140, and in particular the shopping application 146. Similarly, the shopping application 146 may be accessed via a browser or other application in other instances. The client application 108 can be used by the request user to identify various items for addition to their respective virtual shopping cart (or bag), and initiate a purchase on their own. In addition, the sharing functionality of the shopping application 146 can be accessed, as described herein, to allow the requestor to initiate a share to pay request to have another user (e.g., the payor) to pay for their selections.

GUI 112 interfaces with at least a portion of the system 100 for any suitable purpose, including generating a visual representation of the client application 108 and/or the content associated with any components of the eCommerce system 140. In particular, the GUI 112 can be used to present visualizations and pages related to a shopping experience with the merchant(s) associated with the eCommerce system 140 and its shopping application 146. Additionally, the GUI 112 can allow users to request a share to pay transaction, as well as receive information related to a share to pay request from another user and complete or reject requests. GUI 112 can also be used to view and interact with various web pages, applications, and web services located local or external to the client application 108. Generally, the GUI 112 provides the user with an efficient and user-friendly presentation of data provided by or communicated within the system 100. The GUI 112 can comprise a plurality of customizable frames or views having interactive fields, pull-down lists, and buttons operated by the user. In general, the GUI 112 is often configurable, supports a combination of tables and graphs (bar, line, pie, status dials, etc.), and is able to build real-time portals, application windows, and presentations. Therefore, the GUI 112 contemplates any suitable graphical user interface, such as a combination of a generic web browser, a web-enabled application, intelligent engine, and command line interface (CLI) that processes information in the platform and efficiently presents the results to the user visually.

Memory 110 of the client device 102 can represent a single memory or multiple memories. The memory 110 can include any memory or database module and can take the form of volatile or non-volatile memory including, without limitation, magnetic media, optical media, random access memory (RAM), read-only memory (ROM), removable media, or any other suitable local or remote memory component. The memory 110 can store various objects or data, including digital asset data, public keys, user and/or account information, administrative settings, password information, caches, applications, backup data, repositories storing business and/or dynamic information, and any other appropriate information associated with the client device 110, including any parameters, variables, algorithms, instructions, rules, constraints, or references thereto. Additionally, the memory 110 can store any other appropriate data, such as VPN applications, passwords, payment information, firmware logs and policies, firewall policies, a security or access log, print or other reporting files, as well as others. While illustrated within the client device 102, memory 110 or any portion thereof, including some or all of the particular illustrated components, can be located remote from the client device 102 in some instances, including as a cloud application or repository.

Asset management system 102 includes an interface 104 and an outbound transaction interface 104A. Interface 104 is used by the asset management system 102 for communicating with other systems in a distributed environment—including within the system 100—connected to the network 134, e.g., client 136, and other systems communicably coupled to the illustrated asset management system 102 and/or network 134. Generally, the interface 104 comprises logic encoded in software and/or hardware in a suitable combination and operable to communicate with the network 134 and other components. More specifically, the interface 104 can comprise software supporting one or more communication protocols associated with communications such that the network 134 and/or interface's 104 hardware is operable to communicate physical signals within and outside of the illustrated system 100. Still further, the interface 104 can allow the asset management system 102 to communicate with the client 136, and customer managed custody system 116, and/or other portions illustrated within the system 100 to perform the operations described herein.

Interface 104 of the client device 102 is used by the client device 102 for communicating with other systems in a distributed environment—including within the system 100—connected to the network 120. Generally, interface 104 comprises logic encoded in software and/or hardware in a suitable combination and operable to communicate with the network 120. More specifically, the interface 104 may comprise software supporting one or more communication protocols associated with communications such that the network 120 or interface's hardware is operable to communicate physical signals within and outside of the illustrated system 100.

Network 120 facilitates wireless or wireline communications between the components of the system 100 (e.g., between the client devices 102, 122, and eCommerce system 140, etc.), as well as with any other local or remote computers, such as additional mobile devices, clients, servers, or other devices communicably coupled to network 120, including those not illustrated in FIG. 1. In the illustrated environment, the network 120 is depicted as a single network, but can comprise more than one network without departing from the scope of this disclosure, so long as at least a portion of the network 120 can facilitate communications between senders and recipients. In some instances, one or more of the illustrated components (e.g., eCommerce system 140, or portions thereof) can be included within or deployed to network 120 or a portion thereof as one or more cloud-based services or operations. The network 120 can be all or a portion of an enterprise or secured network, while in another instance, at least a portion of the network 120 can represent a connection to the Internet. In some instances, a portion of the network 120 can be a virtual private network (VPN). Further, all or a portion of the network 120 can comprise either a wireline or wireless link. Example wireless links can include 802.11a/b/g/n/ac, 802.20, WiMax, LTE, and/or any other appropriate wireless link. In other words, the network 120 encompasses any internal or external network, networks, sub-network, or combination thereof operable to facilitate communications between various computing components inside and outside the illustrated system 100. The network 120 can communicate, for example, Internet Protocol (IP) packets, Frame Relay frames, Asynchronous Transfer Mode (ATM) cells, voice, video, data, and other suitable information between network addresses. The network 120 can also include one or more local area networks (LANs), radio access networks (RANs), metropolitan area networks (MANs), wide area networks (WANs), all or a portion of the Internet, and/or any other communication system or systems at one or more locations.

In the illustrated example, client device 122 can be associated with a requested party, or payor, who has been requested to complete a share to pay request by a user associated with client device 102. Details of how the client device 122 can receive the shopping cart of the requesting user are described in the following figures. As illustrated, client device 122 may be similar to or differ from client device 102. In some instances, client device 102 may be a mobile device, while client device 122 may be a desktop computer. Similarly, interface 124, processor 124, client application 128, memory 130, and GUI 132 may be similar to or different from client device 102's interface 104, processor 106, client application 108, memory 110, and GUI 112.

eCommerce system 140 is a system for managing one or more shopping applications 146 associated with one or more merchants. In some implementations, users and customers can interact with the shopping application 146 through the eCommerce system 140, and can identify one or more items from particular merchants for purchase. Users can review item catalogs 172 of particular merchants, and can add those items to their cart or bag 180. In some instances, one or both of the client applications 108, 128 may be an extension, agent, or companion application of the shopping application 146.

As illustrated, eCommerce system 140 includes an interface 142, one or more processors 144, shopping application 146, and memory 170. Interface 142 and processor(s) 144 may be similar to or different from interfaces 104, 124 and processor 106, 126, respectively. Processor 144 can be used to execute shopping application 146. In general, shopping application 146 may be a computer program, and may be a standalone program, or combination of components, modules, and other functionality. The shopping application 146 may be a website, backend of a mobile application, or combination thereof. In general, the shopping application 146 can provide shopping functionality 156, which allows the selection of items from one or more item catalogs 172. In some instances, one or more catalog APIs 158 can be used to connect the shopping functionality with an existing item catalog 172, and can allow items to be browsed and selected for purchase or for a requested share to pay. Additionally, a set of cart APIs 160 can allow users to add particular item to their respective virtual shopping carts 180. In doing so, unique carts 180 can be created and identified using a unique identifier 182, which can be associated with corresponding customer data 178. Once items 184 are added to a particular cart, payment APIs 162 can be used to process payments from users or customers to complete purchases. Transaction manager 154 can be part of the solution to manage any payment transactions and guide the customer through the purchasing process. The transaction manager 154 can assist with processing payment, managing backend operations associated with the purchase and completion of sales, and be used to verify and confirm information required for completing the purchasing process.

As described, the present solution can be used to allow share to pay transactions as described. To do so, the shopping application 146 can include a sharing engine 148 or other functionality to assist in the process. The sharing engine 148 can include or provide functionality for receiving an indication from a first client device (e.g., client device 102) that a request for a share to pay process is to be initiated. The sharing engine 148 can include a token generator 150 that can be used to convert a current virtual shopping cart 180 into a token that can be used in the share to pay process. The cart API 160 can be used to identify relevant cart information 180. In some instances, the token can include information that uniquely identifies the cart 180 being shared, as well as each of the items 184 being shared. In some instances, a unique identifier 182 can be associated with, identified by, or included in the token. The token can, in some instances, be an alpha numeric key used to look up the shopping cart information. In some instances, the unique identifier 182 may be the token itself, and can specifically identify the cart information 180 associated with the request. In other instances, the token value may be different from the unique ID 182, and can be stored separately, providing key value pairs to the token value to allow for easy connections to stored carts. Other relevant customer data 178 can be included in the token, or encoded or associated with the token. In general, the token is meant to allow easy access to the existing cart 180 when a second client device associated with a different user tries to finish the share to pay process. With the token, the cart API 160 can access the existing cart 180 of the first user and place those items into the cart of the second user, while still being associated with the first user's request for the share to pay process.

As illustrated, the sharing engine 148 also includes a share link generator 152. The share link generator 152 can include functionality for generating a link that can be shared by the requesting party (i.e., the first user) and can be provided to the requested party (i.e., the second user). The link can be or can include a branch URL. The link can include, among other things, a name of the requesting party, the generated token, an image of one or more of the items in the cart 180 being requested for sharing, and a URL or other triggering link to at least one of a mobile application associated with the underlying merchant or a URL associated with a website associated with the underlying merchant. The shopping application 146 can provide that generated link to the requesting client device 102 via client application 108, and can use either generic messaging applications associated with the operating system of the client device 102 (e.g., iMessage for an iOS-based device) or a proprietary or external messaging application (e.g., WeChat, Messenger, etc.). The client device 102′s messaging functionality, or messaging functionality associated with the client application 108, can be used to send the generated link to a recipient's client device 122, from whom the sending party associated with the client device 102 is requesting to complete the purchase of the items 184 included in the cart 180.

When the link is activated by the client device 122 using client application 128 (or the associated messaging application), the link can trigger opening of the client application 128 and provide the token back to the shopping application 146 to look up the shopping cart 180 associated with the token, and add the identified items to the recipient's cart. In some instances, activating the link may alternatively open up a generic web browser to a URL associated with the eCommerce system 140, and can create a new cart for the payor in a similar manner, allowing the payor to consider completing the transaction via the web site or web-based application. In some instances, the share link can include a deep link which, when activated, can direct users directly to relevant pages within their mobile application associated with the merchant of the eCommerce system 140.

As illustrated, memory 170 of the eCommerce system 140 can be similar to or different than memories 110, 130, and can store customer and item information for those customers and items associated with the eCommerce system 140. As illustrated, one or more item catalogs 172 may be stored in memory 170, either at the eCommerce system 140 or remotely accessible to the eCommerce system 140. Different catalogs 172 may be available to the system 140, and may be used, particularly where a merchant is associated with various brands, or types of items. Memory 170 also stores or references a set of customer data 174 for a plurality of customers, thereby allowing those customers to create accounts and/or complete transactions with the shopping application 146. In some instances, the customer data 174 can include a customer identifier 176, which may uniquely identify a particular customer. Associated with each customer may be the set of customer data 178, which can include information about current shopping carts of the customer (as described), as well as payment information 186. Payment information 186 can be stored to allow for easy payment once a transaction is to be completed. In some instances, payment information 186 may not be stored, and may be input at the time of the transaction and discarded by the merchant upon completion of the transaction. Other relevant customer data 178 can also be stored for registered customers, including shipping information, order histories, preferences, and other information. Any suitable customer-related information can be stored by the system 140.

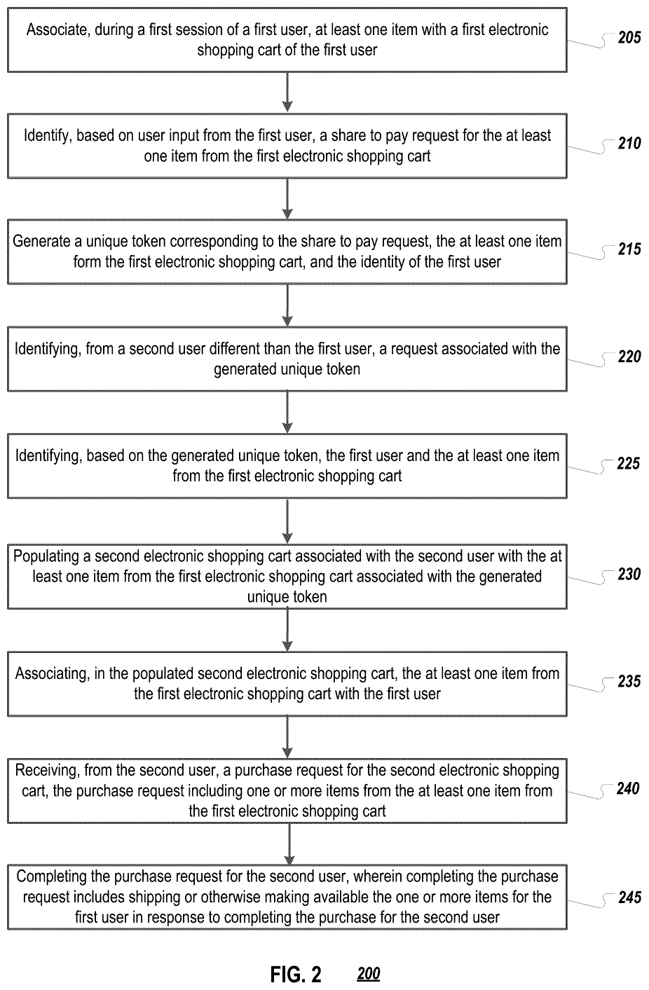

FIG. 2 illustrates an example method for sharing of virtual shopping carts, in accordance with implementations of the present disclosure. For clarity of presentation, the description that follows generally describes method 200 in the context of the system 100 illustrated in FIG. 1. However, it will be understood that method 200 may be performed, for example, by any other suitable system, environment, software, and hardware, or a combination of systems, environments, software, and hardware as appropriate. In some instances, method 100 can be performed by the eCommerce system 140, or portions thereof, described in FIG. 1, as well as other components or functionality described in other portions of this description.

At 205, and during a first shopping session of a first user, one or more items are associated with a first electronic shopping cart of the first user. The first user may be shopping within an application or website, can select available items in particular styles, sizes, or form factors, and can add those items to the first electronic shopping cart. The selected items can be stored, and can be made available for purchase via the application or website once the first user initiates a check out process.

At 210, based on user input from the first user, a share to pay request for at least one of the one or more items is identified. In some instances, a button at the checkout or cart summary page can be provided within the application or website which allows the first user to initiate the share to pay process. When the button is activated, the process commences. In some instances, only a subset of the one or more items included in or associated with the first electronic shopping cart of the first user may be selected for the share to pay process as opposed to the complete set of the one or more items.

At 215, a token is generated to correspond to the share to pay request, and can identify the items in the shopping cart and the identity of the first user. In some instances, the token can use a backend cart API or similar tool to convert information about the at least one item into a token that can be used to continue the share to pay process. In some instances, the token may be an alpha numeric key that can correspond to a unique identifier corresponding to the first user's shopping cart. In other instances, the token may encode or otherwise include information about the items in the first cart and/or the user. The token can be provided to the first user for future sharing purposes, and can be used to later access the stored first shopping cart of the first user.

In some instances, once the token is generated, a further link or shareable element may be generated that includes the token and additional information and data. In some instances, the link can include at least one thumbnail of a particular item included in the share to pay request (and obtained from the backend catalog associated with the item. In some instances, if two or more items are requested, two or more thumbnails may be included in the message being sent to the second user. The link may also include a reference to the customer's name, as well as URLs used to launch a mobile application associated with the merchant at which the process is being performed, and/or a web site associated with the merchant. In some instances, the link may represent a deep link, allowing the mobile application, if installed on the user's device at which the link is activated, to be launched. The link may be provided to the first user to allow them to share their share to pay request with another user. In some instances, only items that are not sold out may be shared. In others, sold out items may be included, as those items may return to stock at some point in the near future.

At 220, a request associated with the generated unique token is identified, where the request is received from a second user different than the first user. In some instances, the unique token can be received in response to the second user receiving and activating the generated link (described in 215). In other instances, a unique ID may be manually submitted via a mobile application associated with the merchant or via the merchant's web page.

In response to receiving and based on the unique token, the first user and the at least one item associated with the first electronic shopping cart can be identified at 225. In some instances, the token can be provided to backend systems, and the associated items of the first shopping cart can be identified. The token may, if encoded, need to be decoded to perform the association. In some instances, the token can be used without modified to identify the corresponding shopping cart of the first user.

At 230, a second electronic shopping cart associated with the second user can be populated with the at least one item from the first electronic shopping cart that is associated with the token. In some instances, the second electronic shopping cart is newly created for the second user. If the second user has an existing second shopping cart prior to activating the link, the at least one item can be added to the existing second shopping cart.

At 235, the at least one item from the first electronic shopping cart of the first user added to the second electronic shopping cart can be associated with the first user. In some instances, this may include highlighted, emphasizing, annotating, or otherwise identifying the items in the second shopping cart as being associated with the first user's share to pay request.

Once the at least one item is added to the second user's electronic shopping cart, the second user can update or modify their cart, including the at least one item. In some instances, the second user may make changes to the size or style of the at least one item. Additionally, the second user is able to remove the at least one item from the cart, as well as add new items for their own shopping.

At 240, a purchase request for the second electronic shopping cart can be received from the second user. The purchase request can include the at least one item associated with the share to pay request, or at least a subset of those items. In some implementations, separate payment processes may be used for items to be purchased for the second user and those items associated with the first user's share to pay process. In others, all of the items in the second electronic shopping cart can be processed together.

At 245, the purchase request of the second user can be completed. In some instances, completing the purchase request and process can include shipping, or otherwise directing the at least one item, to the first user in response to the purchase of the second user. In some instances, information about the first user, including their shipping address, may be available in the system. The second user's purchase may, in those situations, initiate a shipping process to deliver the purchased items directly to the first user without additional second user input. In some instances, the second user may need to direct where the purchased items should be delivered. In still other instances, the purchase of the at least one item may not initiate a shipping process, but instead may allow the second user to notify the first user of the purchase. The first user may then need to take the notification to a designated pick-up location to obtain the items. In other instances, the first user may be automatically notified of the purchase, and can manage the shipping or fulfilment process through their own account.

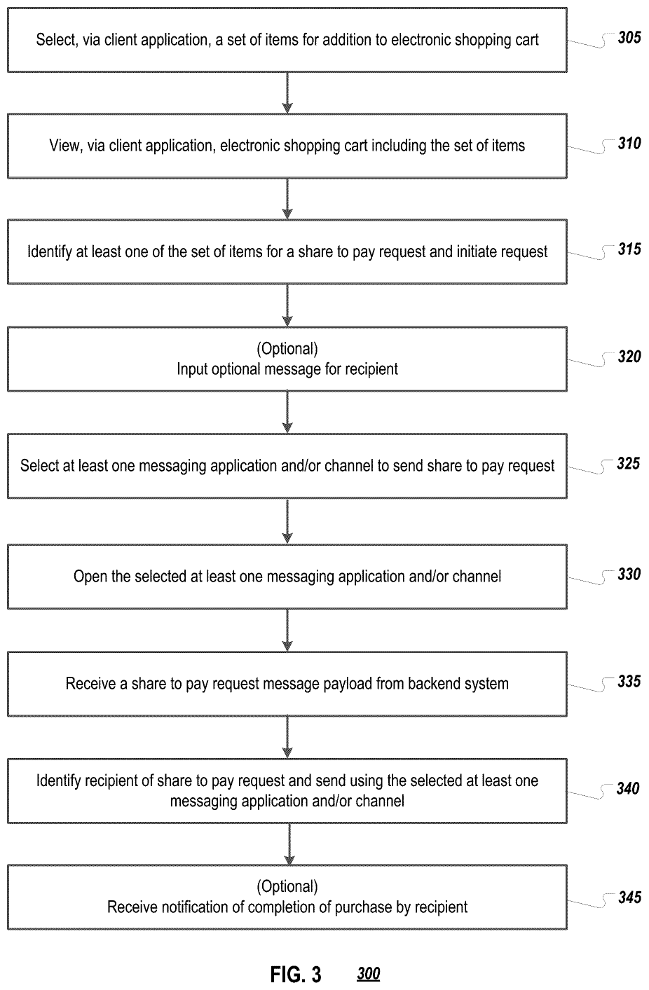

FIG. 3 illustrates an example method 300 for sharing of virtual shopping carts from the perspective of a user requesting a share to pay operation, in accordance with implementations of the present disclosure. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate. In some instances, method 300 can be performed by the eCommerce system 140, or portions thereof, described in FIG. 1, as well as other components or functionality described in other portions of this description.

At 305, a first user can select a set of items for addition to an electronic shopping cart during a shopping or eCommerce session. In some cases, the addition of the items to the electronic shopping cart may be performed using interactions with a mobile application corresponding to a particular merchant or eCommerce platform.

At 310, the first user can view their current electronic shopping cart and the set of items within. At 315, at least one item of the set of items can be selected and associated with a request for a share to pay process. In some instances, some but not all of the set of items in the cart may be eligible for a share to pay process. Those ineligible items may be unavailable for selection. In some instances, a button or UI element can be activated to initiate the share to pay process.

In some instances, the share to pay process may start by requesting input of an optional message from the first user. In some instances, a pop-up or other UI element for inputting text can be added. The optional message can be included with the payload of the message to be sent.

At 325, at least one messaging application and/or channel to be used in sending the share to pay request can be selected. In some instances, particularly where the first user is operating on an iOS system, an iOS Share Sheet can be presented, and can identify any number of messaging applications to use. In some instances, one or more contacts may be suggested as well. At 330, the selected messaging application and/or channel can be opened or otherwise initiated.

At 335, a message payload for the share to pay request can be received from the backend system and input into the selected messaging application and/or channel. As described in other figures, the payload in some instances may be a generated link that includes a token representing the shopping cart of the first user, as well as thumbnail image(s) representing at least one of the items in the cart. Additionally, the payload can include an interactive link that can be used to launch a mobile application or website of the merchant associated with the shopping cart on the other party's devices in response to receiving the request.

At 340, a particular recipient of the share to pay request is identified, and the share to pay request can be sent via the at least one messaging application and/or channel. Once the request is sent, the first user can continue other shopping or leave the application.

At 345, in some optional instances, the first user can receive notification of a completed share to pay request by the recipient. Any suitable notification may be received. In some instances, an app-based notification may be received when the items in the first user's cart are purchased by another from the share to pay process. In other instances, an email or text-based notification of the completed purchase may be received. In some instances, the first user may need to complete shipping or pickup details for the purchased items. In some of those instances, that information may be input via the mobile application or a web page associated with the merchant.

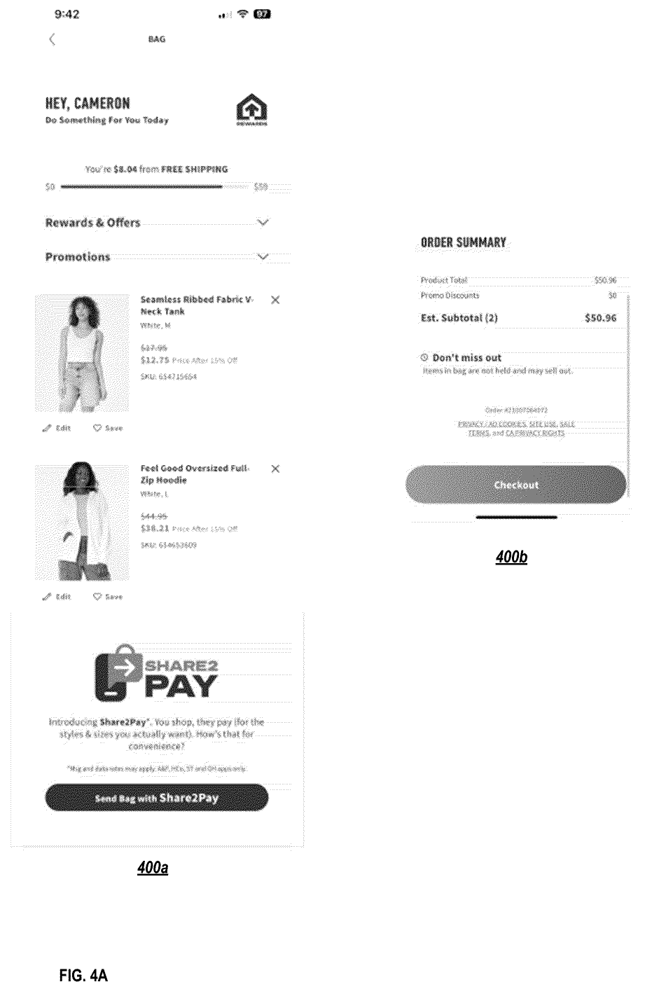

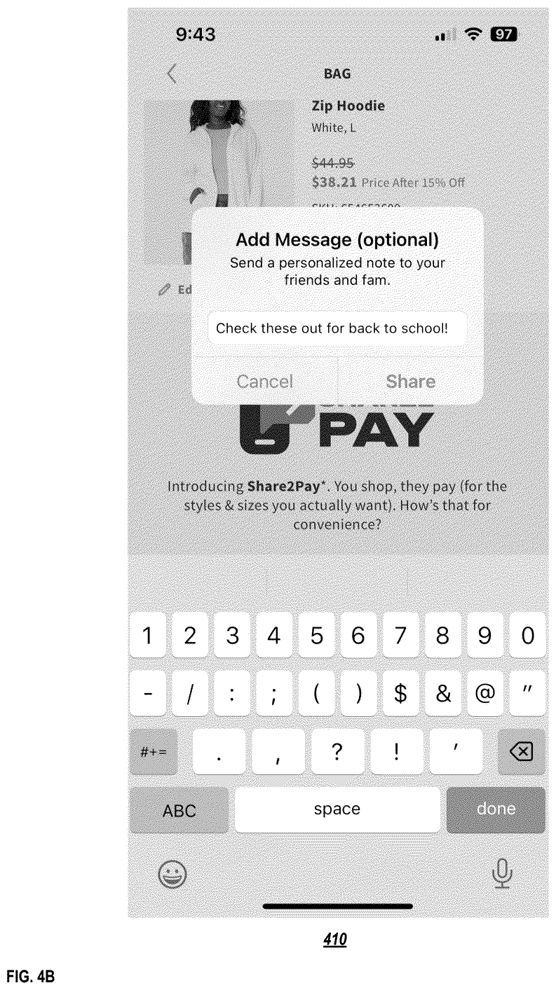

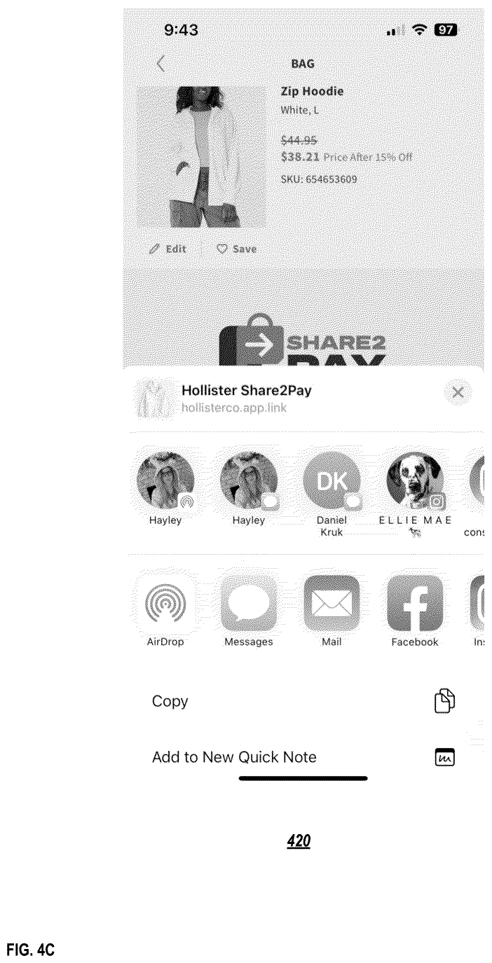

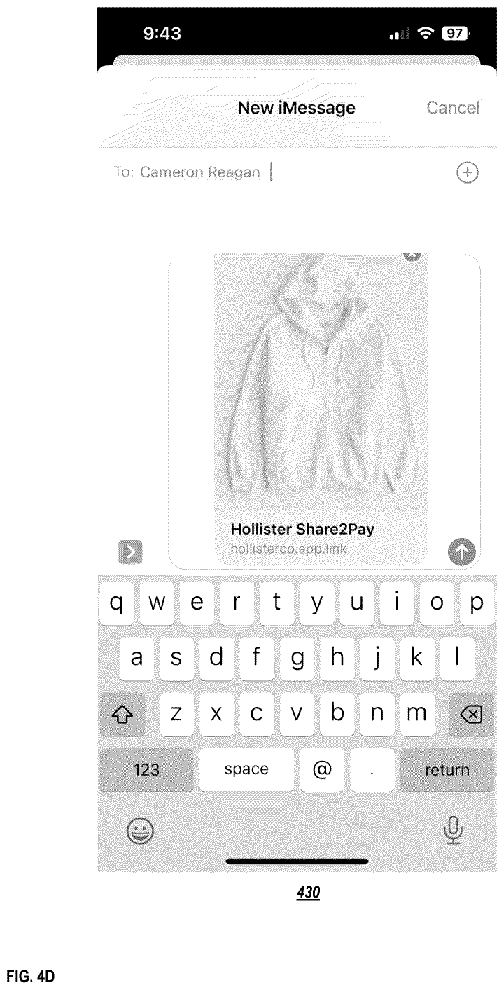

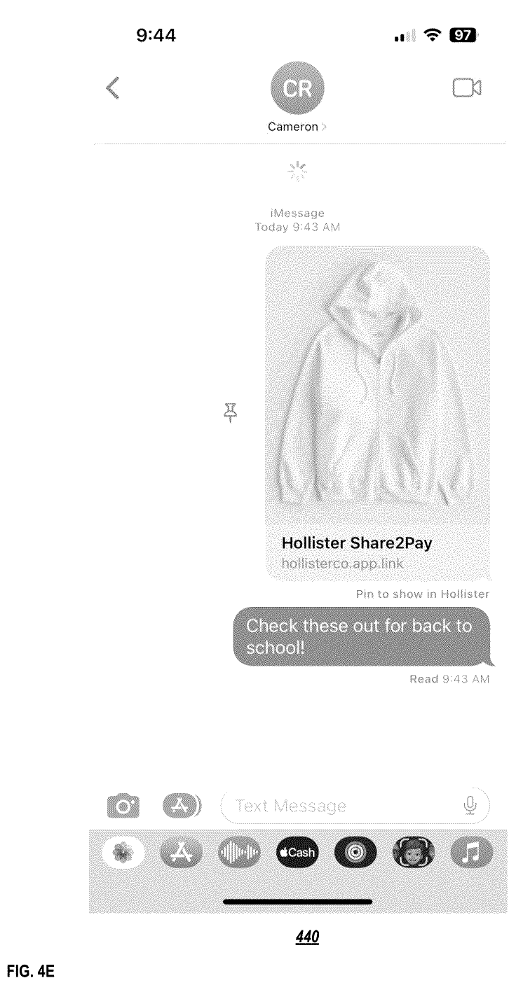

FIGS. 4A-E illustrate example screenshots from the perspective of a user requesting a share to pay operation in one implementation of the present disclosure. These illustrations are merely examples, and variations and different user interfaces can be used.

FIG. 4A illustrates a user interface (UI) (400a and 400b) of a mobile app on a mobile device of the user requesting a share to pay interaction. Cameron, the sharing user, has selected and added two items to his shopping cart for purchase. At this time, Cameron has navigated to the shopping cart page in the mobile app. When reviewing his two selections in the cart, Cameron elects to initiate the Share2Pay functionality illustrated in 400a instead of performing a standard checkout operation.

FIG. 4B illustrates the process after the share to pay button has been pressed. As illustrated in 410, the mobile app can allow the user to input a personal text message to provide to the person(s) to whom they are sharing their cart. In some instances, the message may be a text request for the items, a plea to a purchaser for the items, or an explanation of the reasoning for the request, among others. The user can fill in the text field using their physical or virtual keyboard, or may choose to leave the text blank. In some instances, leaving the message blank may leave no comment in the link to be generated. If the user presses cancel at this stage, the process can be aborted, and a regular checkout can be performed. If the user selects “Share,” then their experience moves to the illustration of FIG. 4C.

At FIG. 4C, an iOS Share Sheet is presented in the UI (420) to identify which messaging application and/or channel is to be selected for the request. In some cases, the message may be sent via a messaging-specific application, such as Messages, WeChat, or Messenger, among others, while in other instances, and email program may be used. In some instances, location-based messaging can be used to share the message, such as through AirDrop or NFC- or Bluetooth-based communication methods. Once the messaging means is selected, a payload is generated for the message.

FIG. 4D illustrates a UI 430 of a message in Apple's Messages app that includes the example generated payload for the share to pay request. As illustrated, a link with embedded information, including a generated token as described here, are included in the generated link. In some instances, the link can include or be associated with an identification of the requesting user. Using the selected messaging application, the user can send the message to their selected contact. While not visible in UI 430, the message input by the user can be sent with the generated payload/link, which includes an image of at least one of the items included in the shopping cart.

FIG. 4E illustrates a UI 440 after the message is sent. As shown, the inputted message is included with the sent message. The sent message can appear similar to other messages in the messaging application, but can be activatable to access the backend eCommerce system, open a related mobile app and/or web site, and populate the receiver's shopping cart with the items included in the share to pay request. To do so, the payload sent in the message can be a branch link which contains various data and information, including the token value generated in response to the share to pay request. As described, the token, or token value, corresponds to a snapshot of the items in the sender's bag, as well as sender information (e.g., including their name or other identifier) if the sender was logged in when the share to pay request was made. The branch link can include a deep link to the mobile application corresponding to the retailer, while also containing a generic web page URL, which can be used to access the retailer's web site if the mobile application is not installed or is not available on the receiver's device.

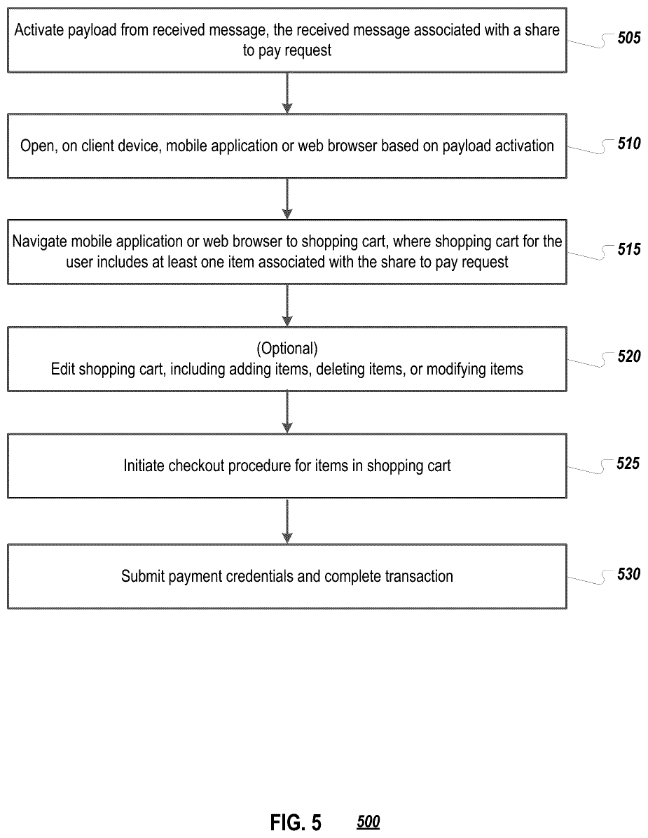

FIG. 5 illustrates an example method 500 for sharing of virtual shopping carts from the perspective of a user receiving a request to perform a share to pay operation, in accordance with implementations of the present disclosure. In some instances, method 500 may be performed by a second user after a first user is associated with method 300 of FIG. 3. For clarity of presentation, the description that follows generally describes method 500 in the context of the system 100 illustrated in FIG. 1. However, it will be understood that method 500 may be performed, for example, by any other suitable system, environment, software, and hardware, or a combination of systems, environments, software, and hardware as appropriate. In some instances, method 500 can be performed by the eCommerce system 140, or portions thereof, described in FIG. 1, as well as other components or functionality described in other portions of this description.

At 505, the receiving user can, via their client device, activate a payload link from a received message associated with a share to pay request. As noted above, the share to pay request can come in any suitable messaging application or channel, including messaging applications, email, wireless sharing apps or functionality, or others. Activating the payload can be performed, in some instances, by touching, clicking on, or otherwise interacting with the payload link generated by the eCommerce system and sent to the user by the requesting user.

In response to the activation of the link, at 510, a mobile application associated with the merchant can open. Alternatively, a web browser may be opened, and a web page of the merchant can be navigated to or opened. In some instances, the link payload can provide a deep link that opens and navigates the mobile application to a specific state or screen, such as the shopping cart functionality of the mobile application. Alternatively, a particular part of the web page of the merchant can be accessed based on a URL specified in the link. At 515, after and/or while navigating to the user's shopping cart, the shopping cart can be updated to visualize the at least one item associated with the share to pay request. The at least one item in the shopping cart can be bolded, highlighted, boxed, or otherwise emphasized and/or annotated to indicate that at least those items are being purchased under a share to pay operation. In some instances, an annotation in the shopping cart can denote that the particular items are being purchased for a named requesting user.

At 520, the user can optionally modify their shopping cart, which can include adding items of their own to the cart, removing one or more existing items in the cart and/or the at least one items associated with the request, and/or modifying specifications or selections associated with the at least one items associated with the request. In some instances, a share to pay process can be completed concurrently with a shopping experience for the recipient. Additionally, changes to the requested items in the share to pay operation can be modified, including for size, color, or other relevant options. In some instances, additional items can be added to be included in the share to pay operation, including those that were not requested by the requesting party. In those instances, the additions may be related to the at least one item requested in the share to pay operation, such as accessories or matching items. In other instances, the additions may be unrelated or only tangentially related to the requested at least one items. Further, no recipient is required to purchase any or all of the items in the share to pay request. If the recipient does not want to purchase the item, they can simply remove the items from their shopping cart.

At 525, once a decision is made to purchase the items, a checkout procedure can be initiated within the mobile application or the merchant web page. In some instances, the purchase of any items specific to the share to pay request may be separated from the items intended for the recipient themselves, while in others, the items in the shopping cart can be processed together. At 530, payment information and credentials can be submitted, provided, or accessed from a user account, and the transaction can be completed.

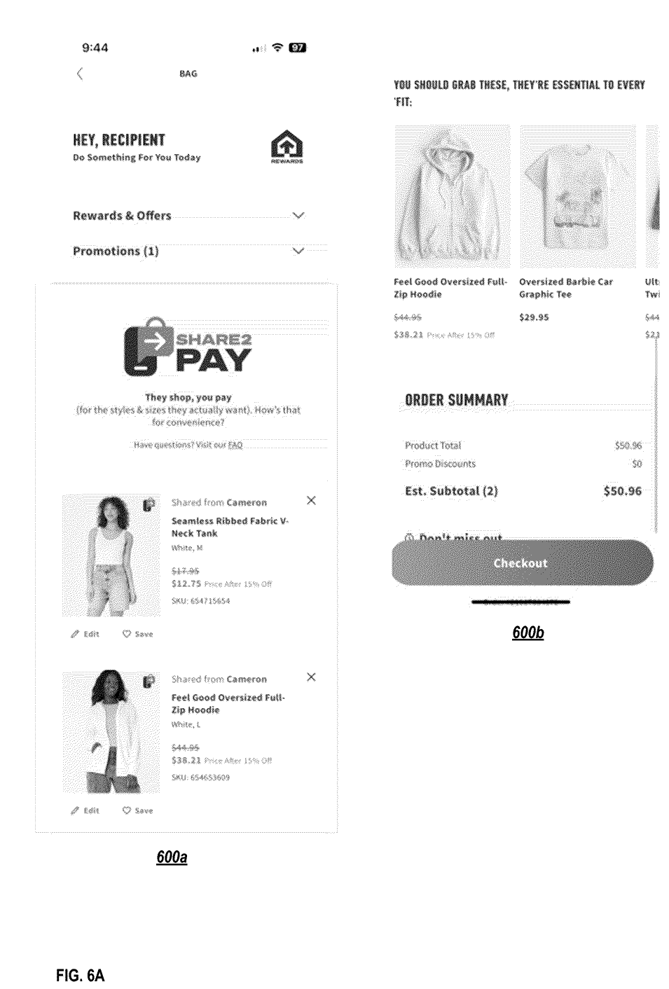

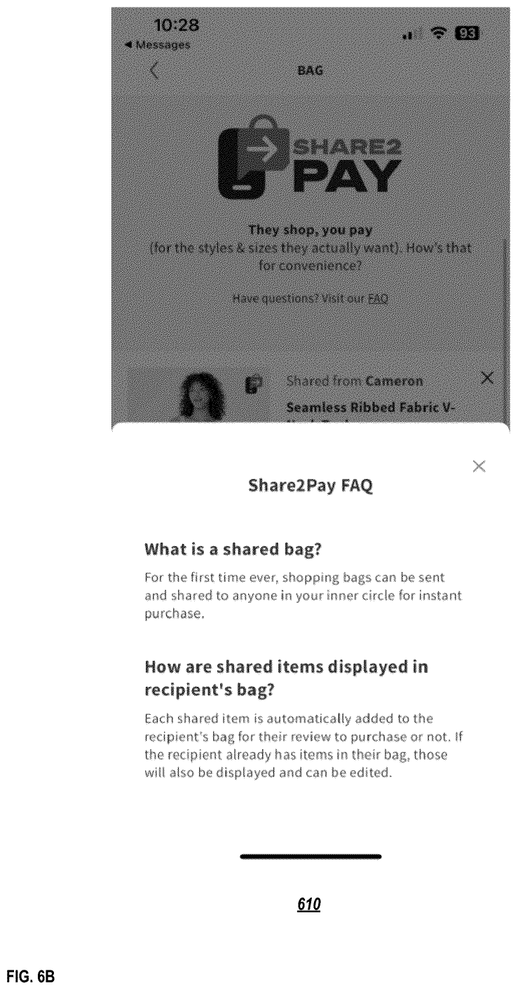

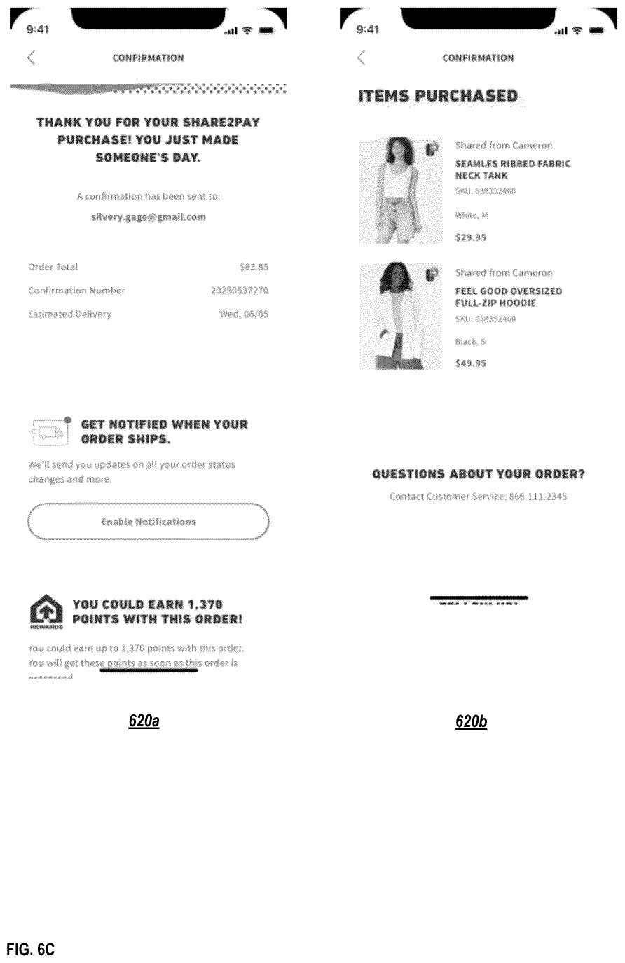

FIGS. 6A-C illustrate example screenshots from the perspective of a user requesting a share to pay operation in one implementation of the present disclosure. These illustrations are merely examples, and variations and different user interfaces can be used.

FIG. 6A illustrates an example UI 600a and 600b after a link associated with a share to pay request has been activated by the recipient. As illustrated, the mobile app associated with the merchant has been opened, and has been navigated to the recipient's shopping cart. Based on the embedded/included token in the link passed to the backend eCommerce system, a set of items associated with the share to pay request are populated into the shopping cart of the recipient. In this instance, it is assumed that the recipient has the relevant mobile app installed. Had the app not been installed, the user may have been taken to a relevant app store to install the application, or may be directed instead to the merchant's web site via a web browser on the client device. As illustrated, the items added from the share to pay process can be annotated or identified within the shopping cart. Here, the items are boxed and include an annotation as “Shared from Cameron.” In this manner, the recipient can immediately understand where those items came from.

In some instances, the recipient may have questions about the share to pay process. As shown in FIG. 6B, a UI 610 can be presented when an FAQ button is activated, which can be used to learn more about the process.

FIG. 6C shows a post-checkout UI 620a and 620b. As illustrated, once the checkout is completed, an indication that a share to pay request has been fulfilled is provided. As illustrated, the fact that a share to pay purchase has been completed can be clear, along with an identification of the particular items being purchased. In some instances, an indication of where the items are to be shipped can be provided, or may be acknowledged that those items are being shipped to the requestor. In some instances, the items may be shipped or made available to the recipient. Again, where the items purchased are listed, a clear annotation of “Shared from Cameron” is provided.

The system described herein can support sharing from multiple requesting users, and can delineate between those particular requests in the recipient's shopping cart. For instance, as illustrated in the example of FIG. 6, two items shared by “Cameron” are illustrated. However, if two share to pay links have been activated by the recipient, both from two different requestors, then each set of requested items may be added to the recipient's shopping cart as illustrated. For example, the first item may be a shirt as shared by Cameron, while the other shirt is an item shared by Jimmy. As such, the first item can be identified as “Shared from Cameron,” while the second shirt may be identified as “Shared from Jimmy.” If the shirts requested by the two users are otherwise identical, those shirts can be shown separately as two different purchases, as opposed to a quantity of two shirts being purchased, as may have happened had the second user added them without the present solution. Additionally, if the second user elects to buy one of the items his or herself, an additional entry separate from the shared items being purchased can be presented and shown.

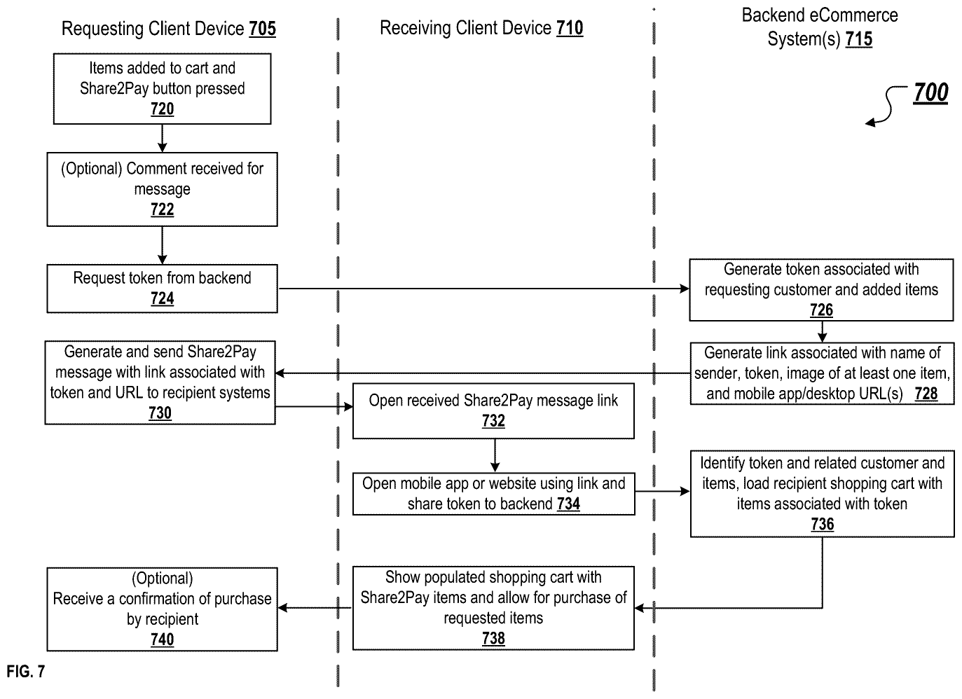

FIG. 7 illustrates a swimlane diagram of example interactions 700 between a requesting client device 705, a receiving client device 710, and a backend eCommerce system 715 for performing a share to pay interaction, in accordance with implementations of the present disclosure. In some instances, the requesting client device may be similar to client device 102, the receiving client device may be similar to client device 122, and the backend eCommerce system may be similar to eCommerce system 140 of FIG. 1, although other systems or components may also be used.

At 720, at a requesting client device 705, items can be added to a first user's cart, and a share to pay button can be pressed, or a share to pay process can otherwise be initiated. In some instances, an optional comment for a share to pay message can be received at 722. A token to be associated with the share to pay process can be requested in combination with the submission of the request at 724. When the submission of the share to pay request is submitted, an indication is provided to the backend eCommerce system 715.

At 726, a unique token associated with the requesting customer and their current shopping cart is generated. The unique token represents a snapshot of the requesting user's shopping cart, and can be used as a reference to obtain the contents of the shopping cart when a recipient initiates their interactions of the share to pay process.

After the token is generated, the backend eCommerce system 715 can generate a link associated with the token for sharing by the first user. The link can include a deep link to a mobile application associated with the system 715 that can take the recipient to a shopping cart page, while also including the generated token to allow the backend eCommerce system 715 to obtain the items from the requestor's shopping cart and place them into the recipient's shopping cart. In some instances, a thumbnail associated with at least one of the items in the first user's cart can be obtained and associated with the link. In some instances, where multiple items are in the first user's shopping cart, more than one image thumbnail can be associated with the link.

Once the link is generated, the link can be returned to the requesting client device 705 associated with the first user. At 730, a share to pay message can be generated, with the link added or embedded into the message. The message can be shared using any suitable messaging application, platform, or channel. In some instances, the first user may select a particular messaging application or channel before the link is generated. Once the link is included in a message, the requesting client device 705 can send that message to at least one receiving client device 710 of a second user.

At 732, the receiving client device 710 can receive the share to pay message received from the requesting client device 705, and can open or otherwise interact with the link included with the message. Based on the link, the device 710 can open a corresponding mobile application associated with the merchant, or can open a web browser or other application to a web page associated with the merchant, at 734. The token included with the link can be provided or passed to the backend system to obtain the relevant items associated with the share to pay request.

At 736, after receiving the token, the backend eCommerce system 715 can identify the received token, and can identify the related first user and shopping cart items associated with the request. Additionally, the backend eCommerce system 715 can load the second user's shopping cart with the identified items related to the first user's request. At 738, the mobile application at the receiving client device 710 can show a shopping cart populated with the share 2 pay request's items, and can allow for the recipient or second user to purchase the requested items.

In some instances, once a transaction is completed using this process, the first user may receive, via the requesting client device 705, a confirmation of the purchase by the recipient based on the share to pay request.

The preceding figures and accompanying description illustrate example processes and computer implementable techniques. But the solution (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, the solution may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

What is claimed is:

1. A computer-implemented method, comprising:
associating at least one item with a first electronic shopping cart associated with a first user, the first electronic shopping cart associated with a merchant;
receiving, from the first user, a request to initiate a share to pay operation for the at least one item associated with the first electronic shopping cart;
generating a token corresponding to the at least one item associated with the first electronic shopping cart based on the received request;
providing the generated token to the first user;
receiving, from a second user different than the first user, a request associated with the generated token;
identifying, based on the generated token, an identity of the first user and the at least one item associated with the first electronic shopping cart; and
populating a second electronic shopping cart associated with the second user with the at least one item associated with the first electronic shopping cart, wherein the second electronic shopping cart is associated with the merchant.

2. The computer-implemented method of claim 1, wherein populating the second electronic shopping cart associated with the second user with the at least one item associated with the first electronic shopping cart comprises associating the at least one item from the first electronic shopping cart with the first user.

3. The computer-implemented method of claim 2, wherein associating the at least one item from the first electronic shopping cart with the first user comprises visually associating the first user with each of the at least one item in a graphical user interface (GUI) presenting the second electronic shopping cart to the second user.

4. The computer-implemented method of claim 1, wherein providing the generated token to the first user comprises:
generating a message payload associated with the requested share to pay operation, wherein the message payload includes the generated token and at least one link to a uniform resource locator (URL) corresponding to a mobile application associated with the merchant; and
wherein the message payload is provided to the first user to transmit to the second user, wherein the second user is selected from a plurality of potential recipients.

5. The computer-implemented method of claim 4, wherein the generated message payload is associated with at least one thumbnail of at least one of the at least one items, wherein the at least one thumbnail is obtained from a catalog associated with the merchant.

6. The computer-implemented method of claim 1, wherein, after populating the second electronic shopping cart with the at least one item associated with the first electronic shopping cart, the method further comprising:
receiving an indication from the second user to modify a particular item from the at least one item associated with the first electronic shopping cart included in the second electronic shopping cart; and
updating the second electronic shopping cart based on the received indication to modify the particular item.

7. The computer-implemented method of claim 1, the method further comprising:
receiving, from the second user, a request to perform a purchase operation for the populated second electronic shopping cart, wherein the purchase operation includes purchasing the at least one item associated with the first electronic shopping cart included in the second electronic shopping cart on behalf of the first user.

8. The method of claim 7, the method further comprising:
initiating, after the purchase operation is complete, a shipping process to deliver the at least one item to the first user.

9. A system comprising:
at least one non-transitory memory storing instructions; and
at least one processor interoperably coupled with the at least one non-transitory memory, wherein the instructions instruct the at least one processor to:
associate at least one item with a first electronic shopping cart associated with a first user, the first electronic shopping cart associated with a merchant;
receive, from the first user, a request to initiate a share to pay operation for the at least one item associated with the first electronic shopping cart;
generate a token corresponding to the at least one item associated with the first electronic shopping cart based on the received request;
provide the generated token to the first user;
receive, from a second user different than the first user, a request associated with the generated token;
identify, based on the generated token, an identity of the first user and the at least one item associated with the first electronic shopping cart; and
populate a second electronic shopping cart associated with the second user with the at least one item associated with the first electronic shopping cart, wherein the second electronic shopping cart is associated with the merchant.

10. The system of claim 9, wherein populating the second electronic shopping cart associated with the second user with the at least one item associated with the first electronic shopping cart comprises associating the at least one item from the first electronic shopping cart with the first user.

11. The system of claim 10, wherein associating the at least one item from the first electronic shopping cart with the first user comprises visually associating the first user with each of the at least one item in a graphical user interface (GUI) presenting the second electronic shopping cart to the second user.

12. The system of claim 9, wherein providing the generated token to the first user comprises:
generating a message payload associated with the requested share to pay operation, wherein the message payload includes the generated token and at least one link to a uniform resource locator (URL) corresponding to a mobile application associated with the merchant; and
wherein the message payload is provided to the first user to transmit to the second user, wherein the second user is selected from a plurality of potential recipients.

13. The system of claim 12, wherein the generated message payload is associated with at least one thumbnail of at least one of the at least one items, wherein the at least one thumbnail is obtained from a catalog associated with the merchant.

14. The system of claim 9, wherein, after populating the second electronic shopping cart with the at least one item associated with the first electronic shopping cart, the instructions instruct the at least one processor to:
receive an indication from the second user to modify a particular item from the at least one item associated with the first electronic shopping cart included in the second electronic shopping cart; and
update the second electronic shopping cart based on the received indication to modify the particular item.

15. The system of claim 9, wherein the instructions instruct the at least one processor to:
receive, from the second user, a request to perform a purchase operation for the populated second electronic shopping cart, wherein the purchase operation includes purchasing the at least one item associated with the first electronic shopping cart included in the second electronic shopping cart on behalf of the first user.

16. The system of claim 15, wherein the instructions instruct the at least one processor to:
initiate, after the purchase operation is complete, a shipping process to deliver the at least one item to the first user.

17. A non-transitory, computer-readable medium storing computer-readable instructions executable by a computer and configured to instruct the computer to:
associate at least one item with a first electronic shopping cart associated with a first user, the first electronic shopping cart associated with a merchant;
receive, from the first user, a request to initiate a share to pay operation for the at least one item associated with the first electronic shopping cart;
generate a token corresponding to the at least one item associated with the first electronic shopping cart based on the received request;
provide the generated token to the first user;
receive, from a second user different than the first user, a request associated with the generated token;
identify, based on the generated token, an identity of the first user and the at least one item associated with the first electronic shopping cart; and
populate a second electronic shopping cart associated with the second user with the at least one item associated with the first electronic shopping cart, wherein the second electronic shopping cart is associated with the merchant.

18. The non-transitory, computer-readable medium of claim 17, wherein populating the second electronic shopping cart associated with the second user with the at least one item associated with the first electronic shopping cart comprises associating the at least one item from the first electronic shopping cart with the first user.

19. The non-transitory, computer-readable medium of claim 18, wherein associating the at least one item from the first electronic shopping cart with the first user comprises visually associating the first user with each of the at least one item in a graphical user interface (GUI) presenting the second electronic shopping cart to the second user.

20. The non-transitory, computer-readable medium of claim 17, wherein providing the generated token to the first user comprises:
generating a message payload associated with the requested share to pay operation, wherein the message payload includes the generated token and at least one link to a uniform resource locator (URL) corresponding to a mobile application associated with the merchant; and
wherein the message payload is provided to the first user to transmit to the second user, wherein the second user is selected from a plurality of potential recipients.
